(19) United States
(12) Patent Application Publication
(10) Pub. No.: US 2023/0278117 A1
(43) Pub. Date: Sep. 7, 2023

(54) METHOD AND APPARATUS FOR INSULATION HANDLING AND CUTTING

(71) Applicant: Mestek Machinery, Inc., Westfield, MA (US)

(72) Inventors: Timothy A. Coon, Lisbon, IA (US); Stanton Sweet, Cedar Falls, IA (US)

(73) Assignee: Mestek Machinery, Inc., Westfield, MA (US)

(21) Appl. No.: 18/115,994

(22) Filed: Mar. 1, 2023

Related U.S. Application Data
(60) Provisional application No. 63/315,649, filed on Mar. 2, 2022.

(51) Int. Cl. B23D 53/04; B23D 55/06; B23D 59/00; B23D 51/16

(52) U.S. Cl. CPC B23D 53/04; B23D 55/065; B23D 59/001; B23D 51/166

(57) ABSTRACT

Disclosed is a cutting apparatus and method of cutting an insulative material. Said insulative material may be either flexible or rigid in nature. The insulative material is cut via a passive cutting wheel driven across a platen and engaged to a stationary drive belt about the passive cutting wheel axis. Engagement of the stationary drive belt with the passive cutting wheel axis results in a turning of the passive cutting wheel.

### APPLICATION CROSS-REFERENCE

The instant Application claims priority to U.S. Prov. Pat. App. No.: 63/315,649 filed on Mar. 2, 2022, the entirety of which is incorporated by reference.

### FIELD OF THE INVENTION

The present invention refers, generally, to a method and apparatus for insulation handling and cutting, and more specially, to a method and apparatus for insulation handling and cutting which utilizes a non-powered but driven cutting wheel to effectuate a cutting operation.

### BACKGROUND OF THE INVENTION

The invention addresses longstanding inefficiencies and problems relating to the handling and cutting of non-rigid materials, such as various types of insulation.

As is known, insulation is utilized across many differing industries, including the HVAC industry where aluminum-backed spun insulation, or other types of non-rigid insulation, are cut and thereafter matched to suitable ductwork for installation.

Typically, this handling and cutting of the insulation workpiece is accomplished in the field, via hand, with some form of straight-edge. This process is of course time consuming, requires attention to detail to protect against physical harm, and oftentimes results in a cut that is not as accurate or as uniform as desired.

Still further, there are cutting apparatuses that utilize powered (i.e., motor driven) cutting wheels for similar operations, yet these apparatuses suffer themselves due to excessive production costs, and by virtue of the necessity of requiring the aforementioned powered cutting wheel, increased complexity. As will also be appreciated, a powered cutting wheel is also costly to maintain and repair.

It is therefore a long felt need in the industry to carry out the handling and cutting of both rigid and non-rigid insulation with an apparatus that satisfies operational, cost and maintenance/repair concerns.

### SUMMARY OF THE INVENTION

The present invention is therefore directed generally to a method and apparatus for insulation handling and cutting, and more specially, to a method and apparatus for insulation handling and cutting which utilizes a non-powered but driven cutting wheel to effectuate a cutting operation.

In certain embodiments of the invention a passive cutting wheel is configured to turn about an axis when transported across a platen. In still other embodiments an edge of the passive cutting wheel extends below a plane defined by an upper surface of the platen during a cutting operation. In still another embodiment the plane of the platen is defined by a cut bar, said cut bar further defining a longitudinal cut recess into which the cutting wheel extends below the upper surface of the platen.

In still another embodiment the height of the height of the cutting wheel vis-à-vis the cut bar and/or the platen is adjusted via adjustable mounting fasteners. In certain embodiments the adjustable mounting fasteners are associated with a wheel carriage engaged to a frame and drive assembly configured to position the wheel carriage, which supports the passive cutting wheel, above the platen. In still another embodiment, the drive assembly propels the wheel carriage bi-directionally enabling the passive cutting wheel to cut material present on the platen in each direction. In certain embodiments a stationary drive belt is configured to extend across the platen and through the wheel carriage. The drive belt may be toothed and configured to engage in matching detents formed in the axis of the passive cutting wheel such that when the wheel carriage is propelled in either direction engagement of the teeth with the detents causes rotation of the cutting wheel about the axis. In still other embodiments, the stationary drive belt is field-replaceable.

In still other embodiments the frame assembly of the cutting apparatus is equipped with stops positioned at either side of the frame assembly. The stops are further configured to sense when the wheel carriage has reached either side of the platen thus causing the wheel carriage to stop and arresting the rotation of the passive cutting wheel. In certain embodiments, the stops are spring-biased pressure sensors.

In another embodiment, the cutting apparatus further comprises an insulation feeding station. The insulation feeding station may be configured to either manually or automatically feed an insulation workpiece to a cutting assembly associated with the passive cutting wheel or to the passive cutting wheel. The insulation workpiece may be either flexible or semi-rigid, or rigid in nature depending upon the configuration of the insulation feeding station.

In certain embodiments of the cutting apparatus, a method of cutting insulation is provided. Such a method would entail first providing a passive cutting wheel as described herein. The passive cutting wheel may be supported by a wheel carriage engaged to a frame and drive assembly. The wheel carriage may then be propelled across the platen. In still other embodiments an insulation workpiece is provided to the passive cutting wheel via an insulation feeding station either manually or in an automated fashion (automatic fashion). In still other embodiments the position of the wheel carriage relative to the distance traveled across the platen is sensed. The sensing of the position may occur via one or more stops. In certain embodiments at least two stops, one at each end of the direction of travel across the platen, are provided.

Finally, in some embodiments of the method of cutting insulation, the height of the passive cutting wheel is adjusted relative to an upper plane of the platen via adjustable mounting fasteners.

### BRIEF DESCRIPTION OF THE DRAWINGS

The invention will be better understood in reference to the drawings, in which:

FIG. 1 is a side, perspective view of an insulation handling and cutting apparatus, according to one embodiment of the present invention.

FIG. 2 is a side, perspective view of the cutting assembly of the insulation handling and cutting apparatus of FIG. 1, prior to effecting a cutting operation on an insulation workpiece.

FIG. 3 is a side, perspective view of the cutting assembly of FIG. 1, after effecting a cutting operation on an insulation workpiece.

FIG. 4 is a side, perspective view of the cutting assembly of FIG. 1, showing repositioning of an insulation workpiece fir subsequent cutting.

### DETAILED DESCRIPTION OF THE INVENTION

In reference to the aforementioned Figures, the present invention will be now described in detail.

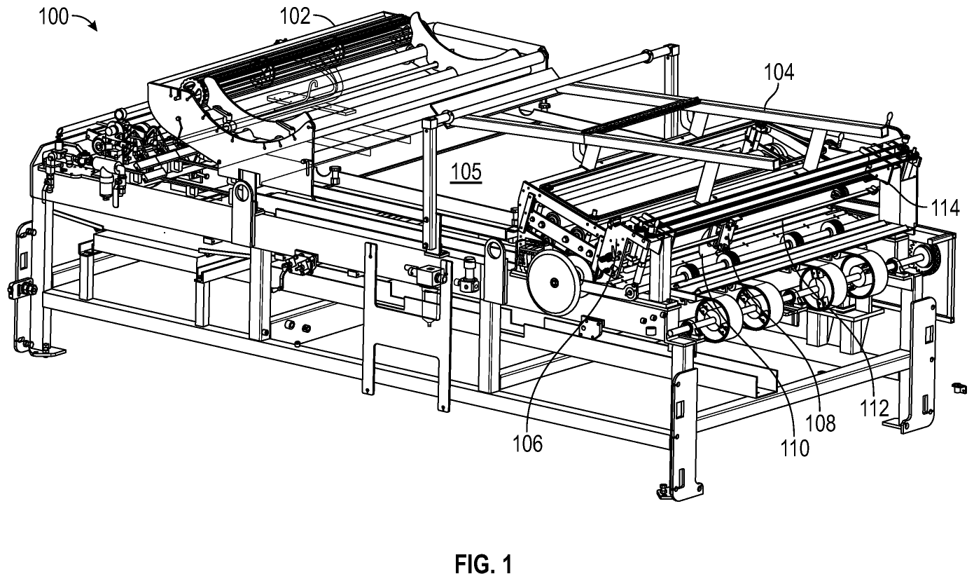

FIG. 1 illustrates a side, perspective view of an insulation handling and cutting apparatus 100, according to one embodiment of the present invention. As shown in FIG. 1, an insulation feeding station 102 is positioned at one end of the insulation handling and cutting apparatus 100, and serves to hold and selectively feed, or dispense, typically non-rigid, wound insulation to the cutting assembly 104, via supporting platen 105.

It will be readily appreciated by one of ordinary skill in the art that while the present insulation handling and cutting apparatus 100 is depicted as having an insulation feeding station 102 for dispensing wound, substantially non-rigid insulation, the present invention is not so limited in this regard, That is, the feeding station 102 may be reconfigured to dispense rigid insulation, or other material workpieces, without departing from the broader aspects of the present invention.

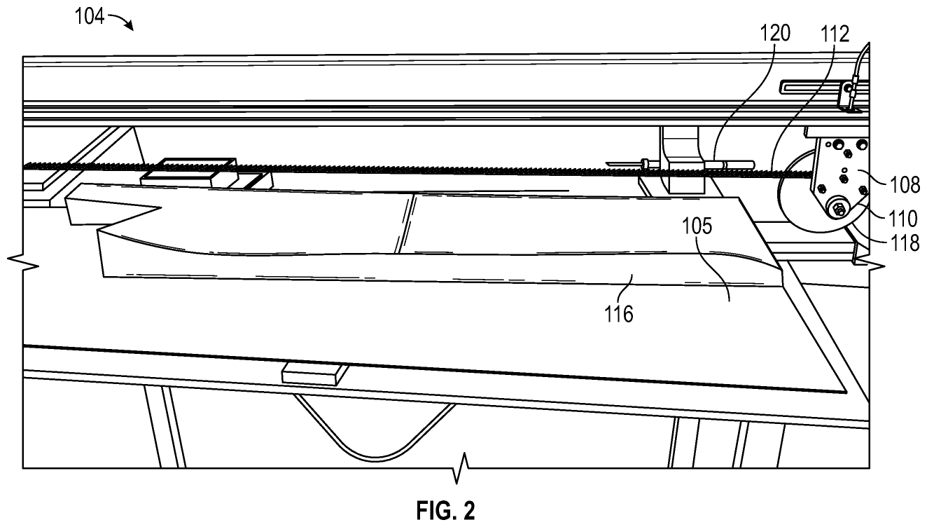

Returning to FIG. 1, the cutting assembly 104 includes a frame and drive assembly 106 for selectively propelling a wheel carriage 108 across the platen 105 during a cutting operation. As will be appreciated, and according to a preferred embodiment of the present invention, the wheel carriage may be rectilinearly driven via the drive assembly 106 so as to enable the cutting of a material workpiece via cutting wheel 110, in both directions, as it transverses the width of the platen 105. FIG. 1 also illustrates a drive belt 112 and stop 114, which will be described in more detail with reference to FIGS. 2-4.

As will be appreciated by one of ordinary skill in the art, the drive assembly 106 may utilize either an electric motor, or a system of pneumatics, to propel the wheel carriage 108 across the platen 105, without departing from the broader aspects of the present invention.

FIG. 2 is a side, perspective view of the cutting assembly 104 of the insulation handling and cutting apparatus 100, with the cutting wheel 110 positioned on one lateral side of the platen 105, prior to effecting a cutting operation on an insulation workpiece 116.

As shown in FIG. 2, while the wheel carriage 108 is itself preferably electrically or pneumatically driven across the platen 105 via drive assembly 106, the integrated cutting wheel 110 is not similarly driven, and is instead a passive element, mounted to the wheel carriage for rotational movement about its axis 118.

The drive belt 112 is strung across the platen 105, and extends through the wheel carriage 108. The drive belt 112 employs a series of teeth, or raised portions, 120 along its length with which to interact with similarly formed tooth portions, or detents, formed on the axis 118 (not shown) of the cutting wheel 110.

As will be readily appreciated, when the wheel carriage 108 is driven across the width of the platen 105, it carries the cutting wheel 110 along therewith, causing the teeth 120 of the stationary drive belt 112 to interact with the complimentary teeth portions, or detents, formed on the axis 118 of the cutting wheel 110. The interaction between the teeth of the stationary drive belt 112 and the complimentary teeth portions, or detents, formed on the axis 118 of the cutting wheel 110 causes the rotation of the cutting wheel, when the wheel carriage is propelled in either opposing direction.

It will be readily appreciated that the speed of rotation of the cutting wheel 110 can be easily controlled by adjusting the speed of the wheel carriage 108, as it is driven across the platen 105 when cutting the insulation workpiece 116.

It is therefore an important aspect of the present invention that while the insulation handling and cutting apparatus 100 employs a driven wheel carriage 108, the cutting wheel 110 itself is not electrically or pneumatically driven. Rather, the motive force for the cutting wheel 110 is generated by the interaction of the teeth 120 of the stationary drive belt 112 with the complimentary teeth, or detents, formed on the axis 118 of the cutting wheel 110.

Further, it will also be readily appreciated that by utilizing a passively-driven cutting wheel 110, the present invention does not require a separate motor or pneumatic adaptation for the cutting wheel 110, and is thus less expensive to manufacture. Moreover, the repairs and replacement of the dive belt 112 are easily done in the field (i.e., “field replaceable,” requiring the unit remain at the location where it is deployed), at substantial time and cost savings, as compared to motor-driven cutting wheels.

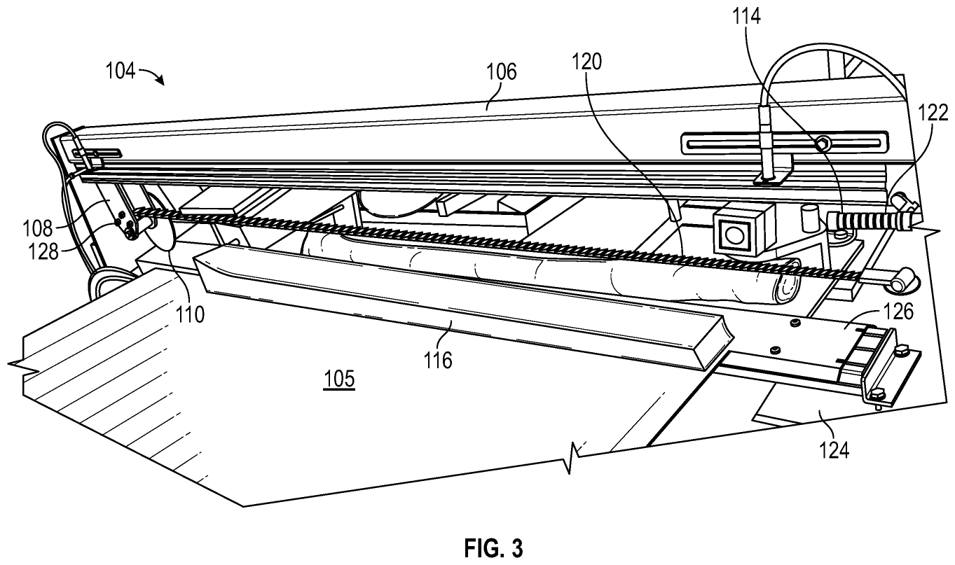

FIG. 3 is a side, perspective view of the cutting assembly 104 of FIG. 1, after effecting a cutting operation on the insulation workpiece 116. As shown in FIG. 3, the cutting wheel 110 has been driven across the platen 105 and rotated via the interaction of the teeth 120 formed on the stationary drive belt 112 with the toothed or detents axis 118 of the cutting wheel 110, thereby cutting the insulation workpiece 116.

All automated operations of the insulation handling and cutting apparatus 100 are preferably coordinated via an integrated computer control system. Such a control system utilizes stops 114, preferably positioned on either side of the frame assembly 106, to sense when the wheel carriage 108 has reached either opposing side of the platen 105, and thus has completed its cutting operation. When so detected by the stops 114, the control system will cause the electrically or pneumatically driven wheel carriage 108 to stop, also arresting the rotation of the cutting wheel 110.

In a preferred embodiment, and as shown in FIG. 3, the stops 114 are spring-biased pressure sensors, whereby the integrated spring elements 122 serve to cushion the arresting of the wheel carriage 108 as it is propelled across the platen 105.

The cutting assembly 104 further includes a cut bar 124 defining a longitudinal cut recess 126 formed therein. The cut bar 124 preferably extends across the platen 105 and provides an elevated support to the insulation workpiece 116 during a cutting operation. Moreover, the cut recess 126 is sized to closely accommodate the edge of the cutting wheel 110, which is mounted to the wheel carriage 108 and frame 106 such that the edge of the cutting wheel 110 extends into the cut recess, below the plane of the platen 105 and the cut bar 124. It will be readily appreciated that the height of the cutting wheel 110 vis-à-vis the platen 105 and/or the cut bar 124 may be easily adjusted via adjustable mounting fasteners 128 of the wheel carriage 108.

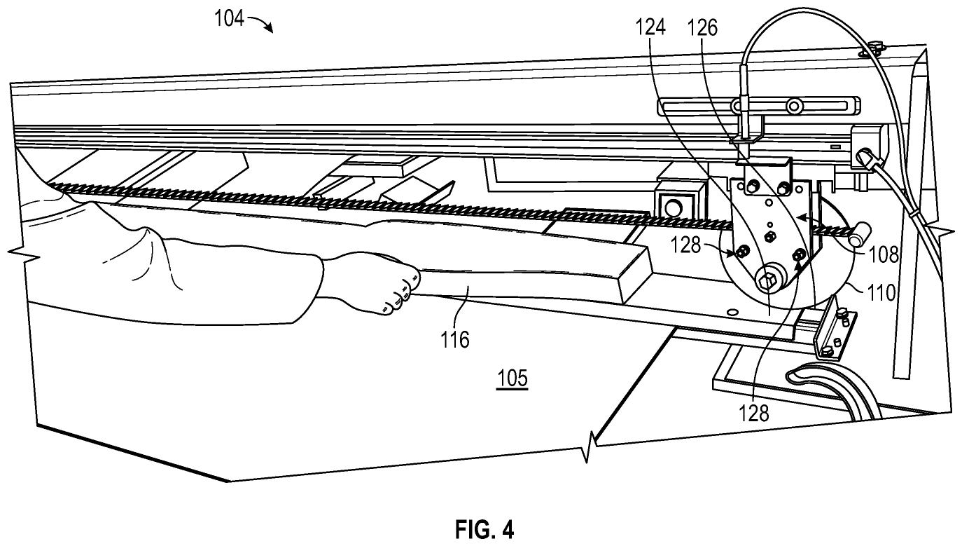

FIG. 4 is a side, perspective view of the cutting assembly 104 of FIG. 1, showing repositioning of the insulation workpiece 116 for a subsequent cutting operation. It will be readily appreciated that the insulation workpiece 116 may be automatically fed to the cutting assembly 104 via the insulation feeding station 102, or manually, without departing from the broader aspects of the present invention.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

As used herein, an element or step recited in the singular and proceeded with the word “a” or “an” should be understood as not excluding plural of said elements or steps, unless such exclusion is explicitly stated. Furthermore, references to “one embodiment” or a “preferred embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

As used herein, ranges and amounts can be expressed as “about” a particular value or range. About also includes the exact amount. Hence “about 5 mm” means “about 5 mm” and also “5 mm.” Generally, the term “about” includes an amount that would be expected to be within experimental error or within the error expected from manufacturing, production, or experimental tolerances. Likewise, the term “approximately” is given similar interpretation in the context of its own usage.

Suitable alterations to the above are readily apparent to those of skill in the art and naturally are encompassed and expressly contemplated. For example, normal manufacturing tolerances may induce variances from the above without departing from the broader scope of this invention.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. A cutting apparatus, comprising:
a passive cutting wheel configured to turn about an axis when transported across a platen.

2. The cutting apparatus of claim 1 wherein an edge of the passive cutting wheel extends below a plane defined by an upper surface of the platen during a cutting operation.

3. The cutting apparatus of claim 2 wherein the plane of the platen is defined by a cut bar, said cut bar further defining a longitudinal cut recess into which the cutting wheel extends below the upper surface of the platen.

4. The cutting apparatus of claim 3 wherein the height of the cutting wheel vis-à-vis the cut bar and/or the platen is adjusted via adjustable mounting fasteners.

5. The cutting apparatus of claim 1 wherein the passive cutting wheel is supported by a wheel carriage engaged to a frame and drive assembly configured to position the wheel carriage above the platen.

6. The cutting apparatus of claim 5 wherein the drive assembly propels the wheel carriage bi-directionally enabling the passive cutting wheel to cut material present on the platen in each direction.

7. The cutting apparatus of claim 1 further comprising an insulation feeding station.

8. The cutting apparatus of claim 7 wherein the insulation feeding station is configured for a flexible and/or roll insulation workpiece.

9. The cutting apparatus of claim 7 wherein the insulation feeding station is configured for a rigid insulation workpiece.

10. The cutting apparatus of claim 5 further comprising a stationary drive belt configured to extend across the platen and through the wheel carriage, said drive belt further comprising teeth.

11. The cutting apparatus of claim 10 wherein the teeth of the drive belt are further configured to engage matching detents formed on the axis of the cutting wheel such that when the wheel carriage is propelled in either direction engagement of the teeth with the detents causes rotation of the cutting wheel about the axis.

12. The cutting apparatus of claim 10 wherein the stationary drive belt is field-replaceable.

13. The cutting apparatus of claim 5 further comprising stops positioned on either side of the frame assembly, said stops configured to sense when the wheel carriage has reached either side of the platen thus causing the wheel carriage to stop and arresting the rotation of the passive cutting wheel.

14. The cutting apparatus of claim 13 wherein the stops are spring-biased pressure sensors.

15. The cutting apparatus of claim 7 wherein the insulation feeding station is further configured to automatically feed insulation workpiece material to the cutting assembly.

16. The cutting apparatus of claim 7 wherein the insulation feeding station is further configured to manually feed insulation workpiece material to the cutting assembly.

17. A method of cutting insulation comprising:
providing the passive cutting wheel supported by a wheel carriage engaged to a frame and drive assembly of claim 5;
propelling the wheel carriage across the platen.

18. The method of cutting insulation according to claim 17 further comprising:
providing an insulation workpiece to the passive cutting wheel via an insulation feeding station.

19. The method of cutting insulation according to claim 17 further comprising:
sensing the position of the wheel carriage relative to the distance traveled across the platen via at least one stop.

20. The method of cutting insulation according to claim 17 further comprising:
adjusting the height of the passive cutting wheel relative to an upper plane of the platen via adjustable mounting fasteners.

21. A cutting apparatus, comprising:
a platen defining a surface for supporting a workpiece to be cut;
a toothed drive belt mounted in operative association with said platen;
a passive cutting wheel having an axis about which said passive cutting wheel rotates when said axis is itself rotated; said axis including contoured features that interact with said toothed drive belt;
a selectively driven wheel carriage affixed to said axis, said wheel carriage ensuring that said contoured features of said axis are held in a touching relationship with said toothed drive belt; and
wherein driven motion of said wheel carriage causes said contoured features of said axis to interact with said toothed drive belt such that said driven movement of said wheel carriage causes rotation of said passive cutting wheel as said wheel carriage is driven along said toothed drive belt.

22. The cutting apparatus according to claim 1, wherein:
said toothed drive belt is selectively adjustable in length and extends a given distance across said platen.
